(19) United States
(12) Patent Application Publication
(10) Pub. No.: US 2007/0291508 A1
(43) Pub. Date: Dec. 20, 2007

(54) Illumination System for Illuminating Display Devices and Display Device Comprising Such an Illumination System

(75) Inventor: Erik Boonekamp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,587

(22) PCT Filed: Jul. 19, 2005
(86) PCT No.: PCT/IB05/52417

§ 371 Date: Jan. 24, 2007

(30) Foreign Application Priority Data
Jul. 29, 2004 (EP) 04103659.1

(51) Int. Cl. F21V 7/00

(52) U.S. Cl. 362/609; 362/608

(57) ABSTRACT

The invention relates to an illumination system (1) for illuminating display devices, comprising: a light emission window (2) for emitting light in the direction of a display device, a reflector (5) for reflecting light, at least a part of which reflector is arranged substantially parallel to and opposite to the light emission window, and a plurality of elongated light sources (6, 9) arranged between said light emission window and said reflector, wherein the surface of each light source is provided with coatings (11) that define multiple elongated light emitting apertures (12), which span each an angle x whose bisector (13) is directed towards the reflectors. The invention further relates to a display device comprising said illumination system.

The invention relates to an illumination system for illuminating display devices. The invention further relates to a display device comprising said illumination system.

Such an illumination system is referred to as a “direct-lit” backlight or “direct-under” type of backlight illumination system. The illumination systems are used, inter alia, for backlighting of (image) display devices, for example for television receivers and monitors. Such illumination systems are particularly suitable for use as backlights for non-emissive displays, such as liquid crystal display devices, also referred to as LCD panels, which are used in (portable) computers or (cordless) telephones. The illumination system is particularly suitable for application in large-screen LCD display devices for television and professional applications.

Said display devices generally include a substrate provided with a regular pattern of pixels which are each driven by at least one electrode. The display device uses a control circuit for reproducing an image or a datagraphic representation in a relevant area of a (display) screen of the (image) display device. In particular, the light originating from the backlight in an LCD device is modulated by means of a switch or a modulator, while various types of liquid crystal effects are being applied. In addition, the display may be based on electrophoretic or electromechanical effects.

In the illumination systems mentioned in the opening paragraph, a tubular low-pressure mercury-vapour discharge lamp, for example one or more cold-cathode fluorescent lamps, hot-cathode fluorescent lamps, or external-electrode fluorescent lamps (EEFL), is/are customarily used as a light source, or alternatively light-emitting diodes (LEDS) may be used as light sources in the illumination system.

In its simplest form, backlights for display devices comprise a number of fluorescent tubes in a rectangular box, The walls are covered with a highly reflective (white) coating on the inside of the box (preferably, the reflection is higher than 97%). The light-emission window is a diffuser or is covered with a diffuser through which light can escape from the box. The uniformity of the light output is usually sufficient in the case of a relatively high lamp density (number of lamps per cm). However, if the lamp density decreases, the uniformity of the backlight also decreases. In such cases the lamp tubes are clearly “visible” through the light-emission window.

The published patent application US-2003/0 107 892 discloses a lamp-reflecting apparatus for use in a “direct-under” type backlight module. The backlight module comprises a plurality of lamps, a diffusing plate disposed above the lamps, and a reflecting plate disposed under the lamps. The lamp-reflecting apparatus provided between the lamp and the diffusing plate comprises a reflecting layer for reflecting light emitted from the lamps towards the bottom reflecting plate. Non-uniformity of light resulting from light being directly emitted to the diffusing plate immediately above the lamps is reduced. A disadvantage of the known illumination system is the limited freedom to optimize uniformity. As a result, the illumination uniformity of the display device is insufficient. In addition, a substantial amount of light is projected just beneath the lamps, which is disadvantageous for the optical efficiency of the backlight.

It is an object of the invention to provide an improved illumination system with which a relatively uniform illumination of a display device can be realized, in a relatively efficient manner.

This object can be achieved by providing an illumination system, comprising: a light emission window for emitting light in the direction of a display device, a reflector for reflecting light, at least a part of which reflector is arranged substantially parallel to and opposite to the light emission window, and a plurality of elongate light sources arranged between said light emission window and said reflector, wherein an elongate surface of each light source is partly provided with at least one coating, thus defining multiple elongate light-emitting apertures, each aperture encompassing a certain angle, wherein the bisectors of said angles are directed towards said reflector. It has been found that, with the particular orientation of the light-emitting apertures of the light source with respect to the light emission window and the reflector, wherein the bisectors of the corresponding aperture angles are directed towards the reflector and opposite to the light emission window, a relatively uniform light distribution can be generated and transmitted through said light emission window, resulting in a relatively uniform illumination of a display device. The fact that the majority of light generated in each light source is emitted directly towards the reflector—and not directly towards the light emission window—provides a major further advantage of the illumination system according to the invention, i.e. that the mutual distances between the light emission window, the reflector, and the plurality of light sources can be kept to a minimum, or at least can be kept relatively small, resulting in an advantageous relatively thin and compact illumination system for display devices. The illumination system according to the invention is particularly suitable for backlight illumination systems with a relatively small thickness, i.e. with a ratio of the height d of the backlight to the diameter D of the light sources in the range: d/D<2. For this reason a display device, such as a Liquid Crystal Display (LCD), can be illuminated relatively uniformly in a relatively efficient and advantageous way. Preferably, said apertures are oriented substantially symmetrically with respect to a standard plane of both the light emission window and the reflector so as to optimize the illumination uniformity of the system. The coating is applied on the light source to reduce its translucence, for which it is noted that the coating may be partly reflective, better known as transflective, but wherein the coating may also be completely, or at least highly reflective. The elongate apertures are formed by parts of the surface of the light source? uncovered by said coating, which is applied on the light source in an interrupted and discontinuous way. It is imaginable that, besides said coating, another coating not playing a part in defining the aperturesis covers an internal and/or external elongate surface of the light source partly or wholly, as for example a known phosphorus? coating. To reduce the terminology to essentials the word ‘coating’ is to be interpreted in this application—without notice to the contrary—as the coating defining the aforementioned apertures.

In a preferred embodiment, the coating defines two light-emitting apertures. It was found to be advantageous in this embodiment to apply a transflective coating on an elongate surface portion of the light source facing the light emission window. Said transflective coating is adapted to reflect a fraction of the incident light and to transmit a complementary fraction of said incident light. This situation will lead to a substantially advantageous three-lobed light distribution around each light source, resulting in a relatively uniform overall distribution of light which can be emitted to the display device.

Normally, the coating will reflect at least part of the incident light in order to achieve the envisaged relatively uniform illumination. Preferably, said coating has a reflectance of between 25% and 100%, more preferably between 30% and 100%, so as to generate a sufficient distinction between light emitted via the apertures on the one hand and light emitted via the (transflective) coating, thus achieving the desired uniform light emission towards the display device on the other hand.

In a preferred embodiment, said coating comprises multiple layers, said layers having mutually different reflectance values. These layers may be applied subsequently on the elongate surface of the light source, e.g. by sputtering, spraying or vapor deposition, thereby forming the actual coating. One of these layers may be formed, for example, by a reflecting layer acting as a concave reflector and deposited on an inner elongate surface of the light source?, whereas a phosphorus? layer is subsequently applied on said reflective coating, thereby forming the aforementioned coating. Parts of the elongate surface of the light source not covered by the coating will form the elongate apertures via which light can be emitted relatively unhindered.

In another preferred embodiment, multiple coatings are applied on different parts of the elongate surface of each light source, said coatings having mutually different reflectance values. In a particular embodiment, a portion of the elongate surface substantially facing the reflector is covered by a substantially reflective coating with a reflectance of over 95%, while an opposite portion of the elongate surface facing the light emission window is covered by a transflective coating, the latter preferably with a reflectance of between 30% and 70%.

Said coating is preferably applied on an external elongate surface of each light source. However, it is also conceivable that said coating is applied on an internal elongate surface of each light source, wherein e.g. a conventional phosphorus? layer can be used as coating. It would be feasible for those skilled in the art to provide one or more coatings on both the inner and the outer elongate surfaces of said light source.

In a preferred embodiment, an elongate surface of each light source substantially directed towards the reflector is covered by a substantially reflective coating covering an angle α₁, wherein α₁ complies with

$${α}_{1} \leq 2 arctan [ \frac{p}{4 {d}_{LR}} ]$$

where p is a pitch of two neighboring light sources, and d_{LR} is the distance between the center of the light source and the reflector, the reflectance of said reflective coating being at least 95%. The pitch p can be considered to be the mutual distance ofthe centers of two neighboring light sources. Light directly emitted by the light source onto said reflective coating will be reflected in multiple directions towards the light emission window. A uniform illumination at the light emission window can be achieved by proper tuning of the reflectance of the light sources.

The positions of the light sources in the illumination system with respect to the light emission window on the one hand and to? the reflector on the other hand play an important part in obtaining a uniform light distribution in the light emission window. To this end, a preferred embodiment of the illumination system according to the invention is characterized in that an elongate surface of each light source substantially directed towards the light emission window is covered by a substantially transflective coating over an angle α₂, wherein the angle α₂ is in the range of:

$$2 arctan [ \frac{p}{2 {d}_{LD}} ] \leq {α}_{2} \leq 2 arctan [ \frac{p}{{d}_{LD}} ]$$

where p is a pitch of two neighboring light sources, and d_{LD} is the distance between the center of the light source and the light emission window. The reflectance of the transflective coating encompassing α₂ is preferably between 30% and 70%.

Preferably, the angle ω enclosed by the normal of the light emission window and a bisector belonging to an aperture is defined by:

$$ω = 180 ° - arctan [ \frac{p}{2 {d}_{LR}} ]$$

where p is a pitch of two neighboring light sources, and d_{LR} is the distance between the center of the light source and the reflector. It is to be noted that the definition of angle ω differs from the definition of angles α₁ and α₂, as angle ω—unlike angles α₁ and α₂—does not indicate the degree of coverage of the elongate surface of the light source by the coatings, but rather a relative orientation of the apertures with respect to both the light emission window and the reflector. A computer program (e.g. employing ray-tracing simulations) may be used to find out what the best configuration is. Such a computer program may be given certain boundaries for certain parameters, for instance that the height h of the illumination system, i.e. de facto d_{LD}+d_{LR}, must not be greater than the height of the conventional illumination system.

Notwithstanding the fact that a relatively uniform illumination of a display device can be achieved in a relatively effective manner by means of the embodiments described above, still a further disadvantage can occur while displaying images on the display device. When relatively fast-moving image material is displayed on a display device, such as an active matrix LCD, the picture sometimes becomes blurred because of the so-called “sample and hold” effect and the slow response of the LC pixels. A scanning backlight creates a stroke of light that scrolls with the same speed as the row-addressing speed from top to bottom of the screen and reduces motion blur significantly, but not completely. To remedy this, a light barrier means is preferably provided between two neighboring elongate light sources, which light barrier means is attached to said reflector. The light barrier means is adapted to separate light emitted by each light source partly or substantially. This or these barrier means can optimize the performance, in this case the motion blur reduction, while maintaining a high level of luminance uniformity over the entire backlight screen. The light barriers are commonly composed of reflective structures. The localization of the light produced by the individual light sources can be strongly influenced by the height, shape, and material of the light barriers. The stroke of light produced by a single light source is quite broad in the absence of light barriers, resulting in a lack of effective motion blur reduction. The overall area uniformity of this backlight construction can be optimized by fine-tuning of the radiation pattern of the lamps. When light barriers means are inserted between the light sources, the stroke of light becomes much narrower, resulting in a strongly improved reduction of motion blur. Preferably, the height h of said light barrier means is defined by:
h≦[D/2+d_{LR}]
where D is the diameter of the neighboring light sources and d_{LR} is the distance between the center of the neighboring light sources and the reflector. For every chosen value of the height h, the radiation pattern of the lamps can be fine-tuned again to ensure perfect uniformity over the whole backlight area. As was mentioned above, the light barrier means is/are preferably applied between two partly coated light sources as described above to achieve both a relatively uniform illumination of a display device and a reduction of blurring effects during a display of moving images. However, it is also imaginable—even though it would be less advantageous—to apply a light barrier means between two conventional light sources not provided with the specially orientated coatings and apertures as elucidated above.

The invention further relates to a display device comprising an illumination system as described in detail above. Besides Liquid Crystal Displays (LCD), all kinds of displays can be used which require active illumination by an external illumination system according to the invention.

The invention will be further described with reference to the following non-limitative embodiment and the drawing, wherein:

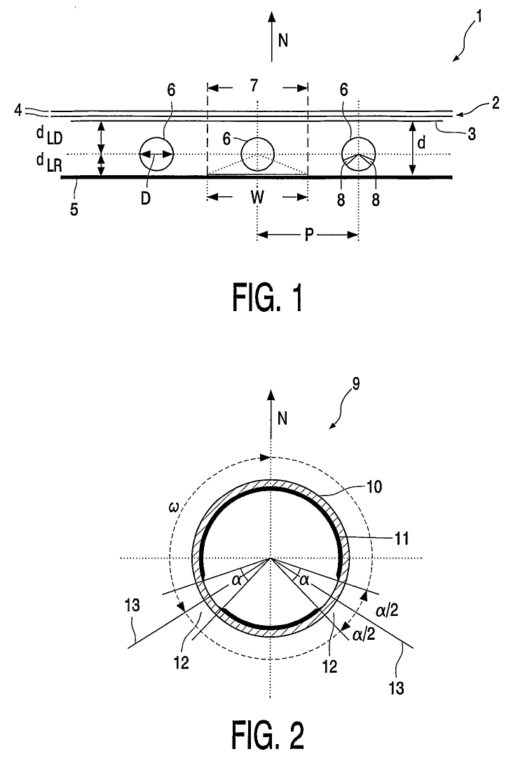

FIG. 1 shows a cross-section of an illumination system according to the invention,

FIG. 2 shows a cross-section of a first embodiment of a light source for use in an illumination system according to the invention,

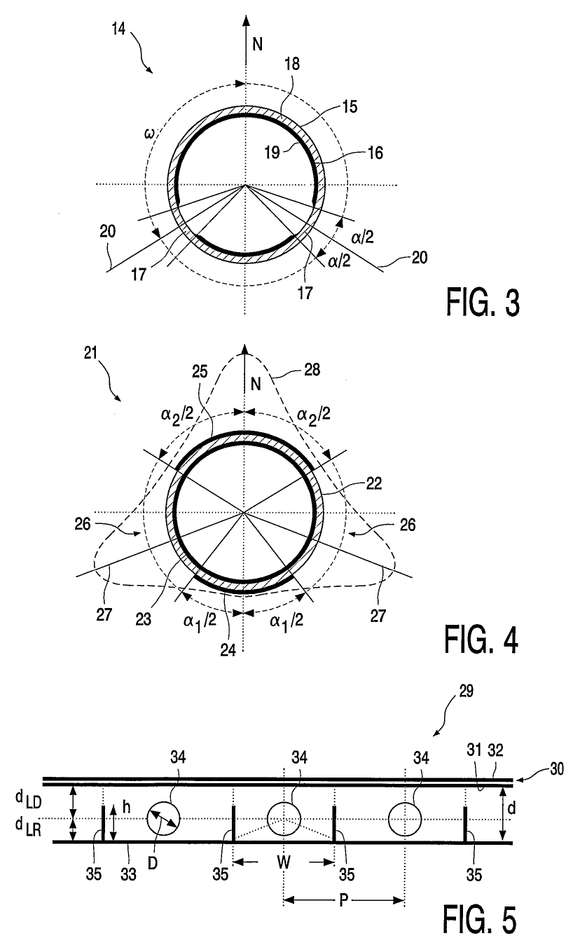

FIG. 3 shows a cross-section of a second embodiment of a light source for use in an illumination system according to the invention,

FIG. 4 shows a cross-section of a third embodiment of a light source for use in an illumination system according to the invention, and

FIG. 5 shows a cross-section of an alternative illumination system according to the invention.

FIG. 1 shows a cross section of an illumination system 1 according to the invention. The illumination system 1 is adapted to illuminate a light requiring display device, such as an LCD. Said illumination system 1 is commonly known as a light box. The system 1 comprises a light emission window 2, said window 2 being composed of a diffuser plate 3 provided with multiple optical foils 4. The system 1 also comprises a reflector 5 which is highly reflective with a reflectance of over 95%. The system 1 further comprises multiple fluorescent lamps 6 adapted to emit substantially white light. Light emitted by said lamps 6 will be transmitted either directly or indirectly (via said reflector 5) through said window 2 towards a display (not shown) to be illuminated. To be able to illuminate the display device in a relatively uniform manner, while aiming to apply a system 1 with a relatively small thickness d, light generated in the lamps 6 must be emitted to the atmosphere surrounding the lamps 6 in a specific and particular manner. To this end, a lamp type as shown in one of FIGS. 2-4 can be used. More details about the particular emission patterns of these lamps 6 are set out hereinafter. For an optimal light distribution the (mutual) dimensioning of components of the illumination system 1 plays an important role. In this non-limitative embodiment the distance d_{LD} between the centre of each lamp 6 and the light emission window 2 measures 15 mm, while the distance d_{LR} between the centre of each lamp 6 and the reflector 5 measures 11 mm, resulting in an internal thickness d of the system 1 of 26 mm. The lamps 6 are positioned in an equidistant way with a pitch p between the centre of two neighbouring lamps 6 of 51 mm. For this reason, the system 1 can be split up into multiple unit cells 7, each cell also having a width w of 51 mm. The diameter of each lamp 6 also plays an important role for determining an optimum emission pattern of the lamps 6 to achieve a uniform illumination of the display device. In the shown example the diameter D of the lamps 6 comes to 16 mm. As is shown schematically in FIG. 1, the lamps 6 are provided with two light emission apertures 8, said apertures 8 are oriented symmetrically with respect to the normal Non the light emission window 2. The bisectors of the apertures 8 of directed towards the reflector 5 to achieve the desired uniform light distribution. More details about this illumination principle are given in FIGS. 2-4.

FIG. 2 shows a cross section of a first embodiment of a light source 9 for use in an illumination system 1 according to the invention. The light source 9 comprises an elongated glass tube 10. An elongated inner surface of said tube 10 is partially provided with a phosphorous coating 11, thereby defining two (uncoated) apertures 12. Each aperture 12 extends over an angle α, wherein the bisector 13 of angle α is directed towards the reflector 5 (shown in FIG. 1). In this embodiment the angle α is set on about 30 degrees. Besides the extent of the apertures 12, also the positioning of said apertures 12 with respect to the normal N plays a role of importance for realising the optimum uniform light distribution, wherein said positioning can be indicated by angle ω, said angle ω being enclosed by the normal N and a bisector 13 of an aperture 12. In the shown embodiment angle ω measures about 113 degrees. Said angle can be optimised for an illumination system by using the following formula:

$$ω = 180 ° - arctan [ \frac{p}{2 {d}_{LR}} ]$$

It is noted that the phosphorous coating 11 has a reflectance of about 50%, whereas the apertures 12 have a (negligible) reflectance. For this reason, the light distribution pattern of the shown light source 9 will commonly possess an advantageous tripod-like emission pattern resulting in a uniform overall emission of light towards the display device.

FIG. 3 shows a cross section of a second embodiment of a light source 14 for use in an illumination system 1 according to the invention. The light source 14 is constructive more or less resemblant to the light source 9 as shown in FIG. 2. The light source 14 comprises an elongated glass fluorescent tube 15, the inner elongated surface of which tube 15 is partially provided with a coating 16, thereby defining two elongated apertures 17. The coating 16 is composed of a diffuse reflective layer 18 which is directly applied onto the tube 15, and a transflective phosphorous layer 19 which is applied onto said reflective layer 18. The reflectance of the diffuse reflective layer 18 can be tuned to achieve perfect uniformity. To further improve the efficiency of the light source 14 the internal glass surface of the aperture area may be coated with an UV reflecting layer (not shown) which is transparent or low reflective in the visible part of the spectrum. For the orientation of the apertures 17 by means of angles α and ω, the bisector 20 of each lamp, and the normal N on the light emission window 2 (shown in FIG. 1) the same reasoning and formula apply as elucidated above in the description of FIG. 2.

FIG. 4 shows a cross section of a third embodiment of a light source 21 for use in an illumination system 1 according to the invention. The light source 21 comprises an fluorescent tube 22. An internal elongated surface of said tube 22 is completely covered with a phosphorous coating 23 with a reflectance of about 50%. An external elongated surface of said tube 22 is partially covered by two different kinds of coatings 24, 25, thereby defining two opposite light emission apertures 26. A lower highly reflective coating 24, normally facing the reflector 5 (as shown in FIG. 1) extends over an angle α₁ of about 75 degrees. Preferably, said angle α₁ is in the range defined by:

$${α}_{1} \leq 2 arctan [ \frac{p}{4 {d}_{LR}} ]$$

Taking the boundaries presented in FIG. 1 taken into account, angle α₁ is preferably lower than about 98 degrees. The lower coating 24 has a reflectance of over 95%. To achieve this high reflectivity diffuse reflective materials such as TiO₂ and Al₂O₃ can be used. Particularly suitable diffuse reflective materials are calcium halophosphate and/or calcium pyrophosphate. Such a reflective material is provided in the form of a paint in which a binder, for example a fluorine copolymer, for example THV, is used, as well as a solvent (for example MIBK). Other additives may be added to the paint mixture, for example those which have improved flowing or mixing characteristics. The upper coating 25 is a transflective coating with a preferred reflectance of between 30% and 70%. The upper coating 25 is normally directed towards the light emission window 2 (shown in FIG. 1) and extends over an angle α₂, wherein α₂ is preferably in the range of:

$$2 arctan [ \frac{p}{2 {d}_{LD}} ] \leq {α}_{2} \leq 2 arctan [ \frac{p}{{d}_{LD}} ]$$

In the shown embodiment the angle α₂ measures about 120 degrees. Applying the values indicated in FIG. 1 in this formula, angle α₂ is preferably between about 118 and about 147 degrees. The bisectors 27 of said apertures 26 are directed downward towards the reflector 5 (as shown in FIG. 1). The light distribution pattern 28 of the light generated within said light source 21 and emitted to the direct surroundings of said light source 21 is substantially three-lobed as is shown by means of the dashed lines. By applying this three-lobed illumination pattern a uniform overall light distribution towards a display device can be obtained.

FIG. 5 shows an cross section of an alternative illumination system 29 according to the invention. The illumination system 29 is more or less similar to the system 1 as shown in FIG. 1. The alternative illumination system 29 comprises a transparent panel 30 consisting of a diffuser plate 31 and multiple optical foils 32 applied onto said plate 31. The system 29 also comprises a highly reflective back plane 33, said back plane 33 being arranged opposite to and substantially parallel to said transparent panel 30. Between said back plane 33 and said panel 30 multiple fluorescent lamps 34, preferably of TL-5 type, with a diameter D of 16 mm, are positioned. The lamps 34 can be formed by one of the lamps 9, 14, 21 shown in FIGS. 2-4 or can be formed by another, preferably equivalent, lamp. In this non-limitative embodiment the distance d_{LD} between the centre of each lamp 34 and the transparent panel 30 measures 15 mm, while the distance d_{LR} between the centre of each lamp 34 and the reflective back plane 33 measures 11 mm, resulting in an internal thickness d of the system 29 of 26 mm. Between every pair of neighbouring lamps 34 a light barrier 35 is positioned, said light barrier 35 being attached to said back plane 33. In this embodiment the light barriers 35 are provided with a reflective coating. In case of a scanning backlight, the stroke of light produced by every individual lamp 34 is limited by the light barriers 35 and is relatively narrow, resulting in an improved reduction of motion blur of moving images visualised on the display device, while maintaining a relatively high level of luminance uniformity over the entire backlight screen. The localisation of the light produced by the individual lamps 34 can be influenced strongly by the height, shape and material of the light barriers 35. To this end, it is also conceivable to apply a patterned back plane 33 thereby incorporating said light barriers 35, said patterned back plane 33 having e.g. sinuate protrusions or the like extending between every two neighbouring lamps 34. The height h of said light barriers 35 does influence the light distribution within the system 29, and does therefore also influence the light emission towards the display device. Preferably the height h is in the range of:
h≦[D/2+d_{LR}+9

Applying the values given above to this formula will give a maximum height h of 19 mm in this embodiment. However, for every chosen height h the radiation pattern of the lamps 34 can be fine-tuned again to ensure perfect uniformity over the whole backlight area, while preventing blurring of moving images visualised on the display device. It is noted that the light barriers 35 are equally spaced at a distance w of 51 mm, said distance w being equal to the pitch p of two neighbouring lamps 34.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Illumination system for illuminating display devices, comprising:
a light emission window for emitting light in the direction of a display device,
a reflector for reflecting light, at least a part of which reflector is arranged substantially parallel to and opposite to the light emission window, and
a plurality of elongated light sources arranged between said light emission window and said reflector,
wherein an elongate surface of each light source is party provided with at least one coating thus defining multiple elongate light emitting apertures, each aperture encompassing a certain angle, wherein the bisectors of said angles are directed towards said reflector.

2. System according to claim 1, characterized in that said coating defines two light emitting apertures.

3. System according to claim 1, characterized in that said coating has a reflectance of between 25% and 100%.

4. System according to claim 1, characterized in that said coating comprises multiple layers, said layers having mutually different reflectance values.

5. System according to claim 1, characterized in that multiple coatings are applied on different parts of the elongated surface of each light source, said coatings having mutually different reflectance values.

6. System according to claim 1, characterized in that said coating is applied onto an external elongated surface of each light source.

7. System according to claim 1, characterized in that said coating is applied onto an internal elongated surface of each light source.

8. System according to claim 1, characterized in that said coating comprises a phosphorus layer.

9. System according to claim 1, characterized in that said coating comprises a specular reflecting and/or a diffuse reflecting layer.

10. System according to claim 1, characterized in that an elongate surface of each light source substantially directed towards the reflector is covered by a substantially reflective coating covering an angle α₁, wherein angle α₁ complies with:
$${α}_{1} \leq 2 arctan [ \frac{p}{4 {d}_{LR}} ]$$
where p is a pitch of two neighboring light sources, and d_{LR} is the distance between the center of the light source and the reflector, the reflectance of said reflective coating being at least 95%.

11. System according to claim 1, characterized in that an elongate surface of each light source substantially directed towards the light emission window is covered by a substantially transflective coating over an angle α₂, wherein the angle α₂ is in the range of:
$$2 arctan [ \frac{p}{2 {d}_{LD}} ] \leq {α}_{2} \leq 2 arctan [ \frac{p}{{d}_{LD}} ]$$
where p is a pitch of two neighbouring light sources, d_{LD} is the distance between the center of the light source and the light emission window.

12. System according to claim 1, characterized in that the angle ω enclosed by the normal of the light emission window and a bisector correspondent to an aperture is defined by
$$ω = 180 - arctan [ \frac{p}{2 {d}_{LR}} ]$$
where p is a pitch of two neighbouring light sources, and d_{LR} is the distance between the center of the light source and the reflector.

13. System according to claim 1, characterized in that between two neighbouring elongated light sources a light barrier means is provided, which light barrier means is connected to said reflector.

14. System according to claim 13, characterized in that the height h of said light barrier means is defined by
h≦[D/2+d_{LR}]
where D is the diameter of the neighbouring light sources and d_{LR} is the distance between the center of the neighbouring light sources and the reflector.

15. System according to claim 13, characterized in that said light barrier means is provided with a reflecting external surface.

16. Display device comprising an illumination system as claimed in claim 1.
